(19) United States
(12) Patent Application Publication
(10) Pub. No.: US 2014/0074592 A1
(43) Pub. Date: Mar. 13, 2014

(54) APPLICATION INSTALL CONVERSION TRACKING SYSTEM

(71) Applicant: MILLMOBILE BV, Amsterdam (NL)

(72) Inventors: Alexander van Elsas, Amsterdam (NL); Jeroen van Dijk, Amsterdam (NL)

(73) Assignee: MillMobile BV, Amsterdam (NL)

(21) Appl. No.: 13/679,162

(22) Filed: Nov. 16, 2012

Related U.S. Application Data
(60) Provisional application No. 61/699,726, filed on Sep. 11, 2012.

(51) Int. Cl. G06Q 30/02

(52) U.S. Cl. CPC G06Q 30/0246
USPC 705/14.45

(57) ABSTRACT

A method of tracking application installations based on an advertisement campaign is disclosed. One embodiment of the method includes: registering a custom URL scheme associated with an advertisement object for a target application, where the custom URL scheme uniquely identifies an installation of the target application; detecting the installation of the target application based on an execution of the custom URL scheme; accessing an interaction record of a user interaction with the advertisement object from an electronic device, the user interaction for downloading the target application; determining a conversion confirmation based upon the interaction record and the detected installation; and reporting the conversion confirmation of the installation associated the user interaction.

### CROSS REFERENCE TO RELATED APPLICATION

This application claims the benefit of U.S. Provisional Patent Application Ser. No. 61/699,726 filed Sep. 11, 2012, and the subject matter thereof is incorporated herein by reference thereto.

### FIELD OF INVENTION

This invention relates generally to an advertisement targeting platform, and in particular to an advertisement targeting system with an application install conversion tracking mechanism for tracking the application install triggered by an advertisement campaign.

### BACKGROUND

Digital advertisement distribution offers a unique opportunity to present multimedia advertisement objects to consumers who use electronic devices, including mobile devices. Some of these advertisement distributions are targeted at particular audience types.

Existing audience targeting methods involve access to unique device identifier (UDID). Access to UDID raises concerns in consumers of today, and may be difficult to implement. Thus, a need remains for an effective advertisement distribution method with audience targeting mechanisms that can overcome the issues with the existing advertisement targeting techniques. Solutions to these problems have been long sought but prior developments have not taught or suggested any solutions. Accordingly, viable solutions to these problems have eluded those skilled in the art.

### DISCLOSURE OF INVENTION

The present invention includes a method of tracking application installations based on an advertisement campaign. One embodiment of the method can include: registering a custom URL scheme associated with an advertisement object for a target application, where the custom URL scheme uniquely identifies an installation of the target application; detecting the installation of the target application based on an execution of the custom URL scheme; accessing an interaction record of a user interaction with the advertisement object from an electronic device, the user interaction for downloading the target application; determining a conversion confirmation based upon the interaction record and the detected installation; and reporting the conversion confirmation of the installation associated the user interaction.

The method can be performed with an advertisement targeting platform system. The advertisement targeting platform system can includes modules on a server to execute the method steps described above. The advertisement targeting platform system can receive device information from a detection application executing on an electronic device that assists in sending information of the electronic device to the modules on the server.

In another embodiment, a method of tracking an application download via an on-device application can include: receiving a custom URL scheme associated with an advertisement object, where the custom URL scheme uniquely identifies an installation of a target application; generating a unique identifier to record a user interaction with the advertisement object on an electronic device, the user interaction for downloading the target application; storing the unique identifier; detecting the installation of the target application based on an execution of the custom URL scheme; determining a conversion confirmation based upon the unique identifier and the detected installation; and reporting the conversion confirmation of the installation associated the user interaction.

The on-device application can be a downloadable application, such as a mobile application. The on-device application can also integrate with other mobile applications, such that it is executed in parallel at the launch of the integrated mobile applications. The on-device application can be stored on a non-transitory storage medium, such as a mobile phone internal memory, and can be executed by a processor, such as a mobile phone processor.

One advantage of this invention includes that the system can track advertisement performance with application download campaigns. The system allows tracking of whether an advertisement causes a consumer to download or install an application. The tracking can be performed without storing the device identifier (UDID), thus reducing privacy concerns. Combined with the consumer profiler system, the advertiser can gain information not only about the conversion rates of its advertisement campaigns, but also the profiles of likely converts.

Some embodiments of the invention have other aspects, elements, features, and steps in addition to or in place of what is described above. These potential additions and replacements are described throughout the rest of the specification.

### BRIEF DESCRIPTION OF THE DRAWINGS

FIG. 1 is a system architecture of a consumer target platform.

FIG. 2 is a control flow of an application detection system.

FIG. 3 is a control flow of a consumer profiler system.

FIG. 4 is a control flow of an advertisement targeter system.

FIG. 5 is an example of a flow chart of a method of tracking application installations based on an advertisement campaign.

FIG. 6 is an example of a flow chart of a method of tracking an application download via an on-device application.

FIGS. 7A-7D illustrate examples of an advertiser dashboard.

FIG. 8 is a diagrammatic representation of a machine in the example form of a computer system within which a set of instructions, for causing the machine to perform any one or more of the methodologies or modules discussed herein, may be executed.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

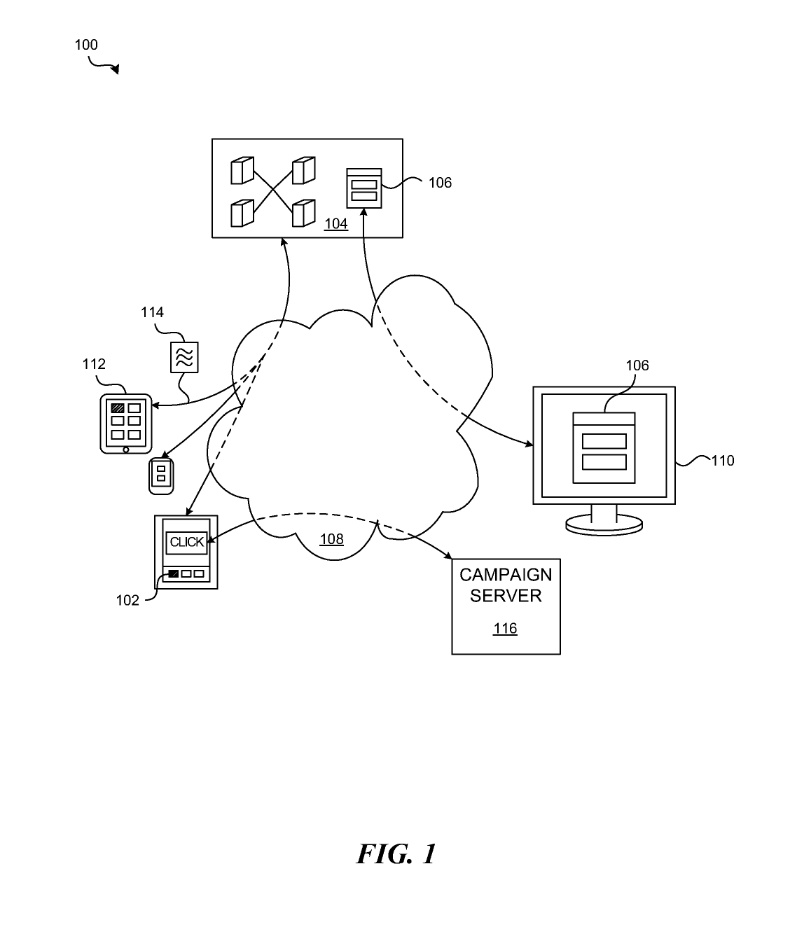

Referring now to FIG. 1, therein is shown a system architecture of a consumer target platform 100. The consumer target platform 100 can include a detection application 102, a profile server system 104, and an advertiser dashboard 106.

The detection application 102 and the profile server system 104 can be coupled via a network channel 108. The advertiser dashboard 106 can be provided by the profile server system 104 and displayed on a monitor 110 coupled to the profile server system 104 via 108. The network channel 108 is a system for communication. The network channel 108 can encompass a variety of mediums of communication, such as wired communication for one part and wireless communication for another part. The network channel 108 can be part of the Internet.

For example, the network channel 108 can include an Ethernet or other wire-based network or a wireless NIC (WNIC) or wireless adapter for communicating with a wireless network, such as a WI-FI network. The network channel 108 can include any suitable network for any suitable communication interface. As an example and not by way of limitation, the network channel 108 can include an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As another example, the network channel 108 can be a wireless PAN (WPAN) (such as, for example, a BLUETOOTH WPAN), a WI-FI network, a WI-MAX network, a 3G or 4G network, a cellular telephone network (such as, for example, a Global System for Mobile Communications (GSM) network).

In one embodiment, the network channel 108 can use standard communications technologies and/or protocols. Thus, the network channel 108 can include links using technologies such as Ethernet, 802.11, worldwide interoperability for microwave access (WiMAX), 3G, 4G, CDMA, digital subscriber line (DSL), etc. Similarly, the networking protocols used on the network channel 108 can include multiprotocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP). The data exchanged over the network channel 108 can be represented using technologies and/or formats including the hypertext markup language (HTML) and the extensible markup language (XML). In addition, all or some of links can be encrypted using conventional encryption technologies such as secure sockets layer (SSL), transport layer security (TLS), and Internet Protocol security (IPsec).

The detection application 102 is a software application executable on an electronic device, with instructions stored on a non-transitory storage medium of the electronic device. The detection application 102 is for performing application detection on a hardware machine. For example, the detection application 102 can be installed on a mobile device to detect software applications running on or installed on the electronic device. The detection application 102 can also detect metadata stored on an operating system of the electronic device and report back to the profile server system 104, where the profile server system 104 can detect software applications running on or installed on the electronic device based on the detected metadata. The metadata can be an application footprint and device information such as hardware type, operating system information, and device name.

The detection application 102 can be coupled to the profile server system 104. The detection application 102 can be distributed from the profile server system 104 to electronic devices 112. The detection application 102 can communicate with the profile server system 104 upon execution. The detection application 102 can also execute pre-transferred instructions from the profile server system 104 upon request from the profile server system 104.

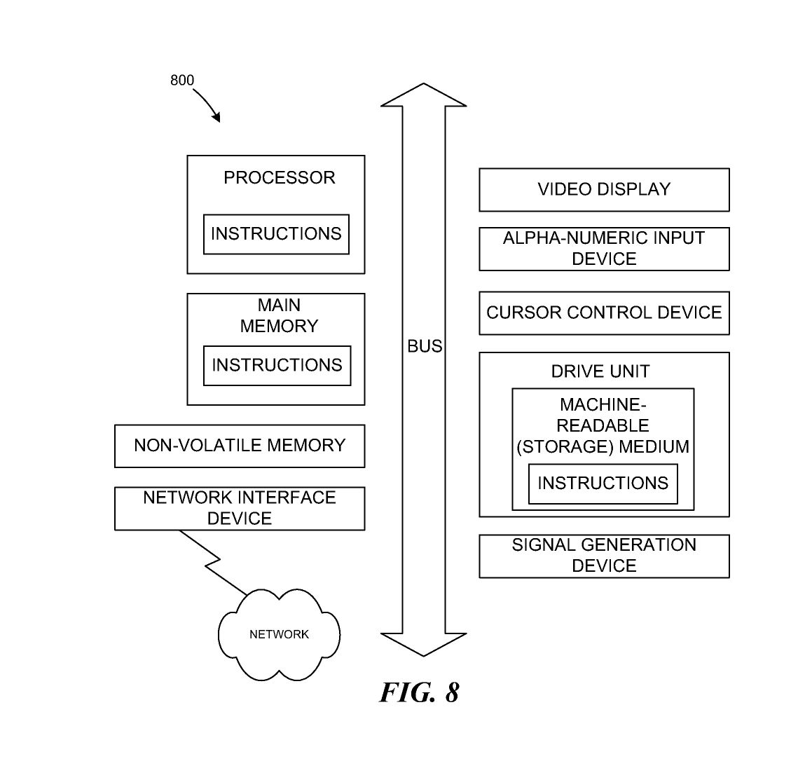

The profile server system 104 is a computer system including one or more devices with computing functionalities. For example, the profile server system 104 can be a computer system 800 of FIG. 8. The profile server system 104 can be for distributing the detection application 102 to the electronic devices 112. The profile server system 104 can also be for generating a target audience profile from an application list 114. The application list 114 is a list of software applications related to a particular electronic device monitored by the profile server system 104. The application list 114 can include a list of applications currently running on an electronic device, installed on the particular electronic device, or both. Each entry of the application list 114 can include an indication of whether an application is running on the electronic device and an indication of whether an application is installed on the electronic device.

The advertiser dashboard 106 is a user interface generated for advertisers. For example, the advertiser dashboard 106 can be generated by the profile server 104. The advertiser dashboard 106 can be an interactive digital page. The advertiser dashboard 106 can receive targeting options from advertisers. For example, the advertiser dashboard 106 can receive target audience categories, such as age range, gender, special interest group, or any combination thereof. The advertiser dashboard 106 can configure the received targeting options on the profile server system 104.

After targeting options are configured on the profile server system 104, the profile server system 104 can generate an advertisement target map for specific advertisement objects and target audience profiles. The generating can be based on the targeting options inputted on the advertiser dashboard 106. The profile server system 104 can perform detection of the application list 114 on all available electronic devices. For each of the electronic devices 112, the profile server system 104 can determine a target audience profile based on the application list 114 detected. The profile server system 104 can then determine which advertisement object to present to the electronic device based on the target audience profile and the advertisement target map.

Once which advertisement object to present is determined, the detection application 102 can request the advertisement object from a campaign server 116. The campaign server 116 is a server computer system. The campaign server 116 can be the computer system 800 of FIG. 8. The campaign server 116 stores advertisement objects belonging to advertisement campaigns. A message sent to the campaign server 116 for retrieval with a campaign identification can trigger the campaign server 116 to send the advertisement campaign along with the advertisement object to the requesting device. The electronic devices 112 can include mobile devices, such as a tablet or a smart phone.

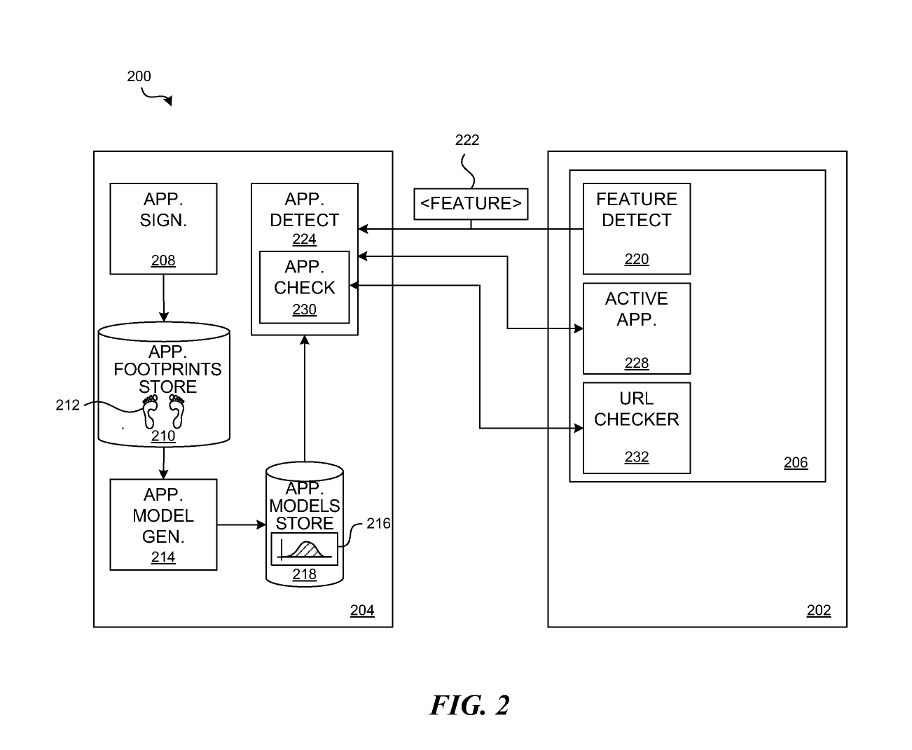

Referring now to FIG. 2, therein is shown a control flow of an application detection system 200. The application detection system 200 can be part of the consumer target platform 100 of FIG. 1. The application detection system 200 is for detecting a list of application installed on or running on an electronic device. The application detection system 200 can include an electronic device 202 and a server system 204. The electronic device 202 is an electronic device with computer functionalities capable of executing a detection application 206. The electronic device 202 can be a mobile device, such as a tablet or a smart phone. The electronic device 202 can be one of the electronic devices 112 of FIG. 1. The detection application 206 can be the detection application 102 of FIG. 1.

The server system 204 is a computer system with at least one processor and one non-transitory memory. The server system 204 can be the profile server system 104 of FIG. 1. The server system 204 can be a computer system 800 as described in FIG. 8.

The application detection system 200 can include one or more methods of detecting applications on an electronic device. The one or more methods can be implemented by components, storages, and modules described below. The modules can be implemented as hardware components, software modules, or any combination thereof. For example, the modules described can be software modules implemented as instructions on a non-transitory memory capable of being executed by a processor or a controller on a machine described in FIG. 8.

Each of the modules can operate individually and independently of other modules. Some or all of the modules can be combined as one module. A single module can also be divided into sub-modules, each performing separate method step or method steps of the single module. The modules can share access to a memory space. One module can access data accessed by or transformed by another module. The modules can be considered “coupled” to one another if they share a physical connection or a virtual connection, directly or indirectly, allowing data accessed or modified from one module to be accessed in another module.

The storages or “stores”, described below are hardware components or portions of hardware components for storing digital data. Each of the storage can be a single physical entity or distributed through multiple physical devices. Each of the storage can be on separate physical device or share the same physical device or devices. Each of the stores can allocate specific storage spaces for run-time applications.

The application detection system 200 can include additional, fewer, or different modules for various applications. Conventional components such as network interfaces, security functions, load balancers, failover servers, management and network operations consoles, and the like are not shown so as to not obscure the details of the system.

The server system 204 can include an application signature module 208. The application signature module 208 is a module for collecting expected application metadata. The expected application metadata are predictions of application metadata that can be detected when an application is installed on an electronic device.

The application signature module 208 can collect expected application metadata from one or more application communities. For example, the application signature module 208 can include an interface to input application metadata. The application signature module 208 can also execute a web crawler to browse, download, and/or parse application-related pages from application websites and application stores, such as iTune store, Google Play Store™, Chrome™ Web Store, or any combination thereof. Examples of expected application metadata can include a custom URL scheme to launch the application, the version number of the application, the version date of the application, the application size (memory size), the application run-time memory usage, the application run-time processing usage, the application title, the application privacy setting, the application access setting, or any combination thereof.

The custom URL scheme is defined as a unique uniformed resource locator (URL) that an operating system can use to launch one application from within another application. For example, a custom URL scheme on the iOS™ for Facebook™ can be “http://fb”. The application detection system 200 can detect applications by asking the operating system of an electronic device whether a set of custom URL schemes can be opened. When the operating system responds positively, then the application detection system 200 can determine that the application associated with or defining the custom URL scheme is installed on the electronic device.

The server system 204 can include an application footprints store 210. The application signature module 208 can store the collected application metadata of an application as an application signature 212. The application signature 212 is a set of metadata associated with an application.

The server system 204 can include an application model generator 214. The application model generator 214 is for generating an application model 216 from the application footprints store 210. The application model 216 is an active data function associated with an application. The application model 216 can be executed by a module of the application detection system 200 for determining whether the associated application is installed on or running on an electronic device based on detected metadata features on the electronic device. For example, the application model 216 can be a probabilistic model that associates a probability of whether an application is installed or running on an electronic device based on values of metadata features. A threshold can be associated with each of the application model 216, such as a confidence threshold where beyond a certain probability, an application is determined as being installed on or running on the electronic device. For example, the application model 216 can be a Gaussian Mixture Model, a Markov Model, minimum distance model, or any combination thereof. The application model 216 can also output a score indicating likelihood of a matched application. The score can be between the values 0-1.

The electronic device 202 and/or the server system 204 can include an application model store 218. The application model store 218 is a store for recording and providing access to application models. When metadata features detected on an electronic device is run against one of the application model 216, the application model 216 can determine whether the electronic device is running or has installed an application associated with the application model 216. Each of the application model 216 can be stored in the application model store 218.

The electronic device 202 can include a feature detection module 220. The feature detection module 220 is for dynamically detecting metadata features 222 on the electronic device 202. For example, the feature detection module 220 can detect the metadata features 222 stored on a non-transitory memory of the electronic device 202. The metadata features 222 are aspects of an electronic device. The metadata features can also be aspects of running or installed applications as reflected on an electronic device. For example, the metadata features 222 can include aspects of the operating system, the application's use of the cache memory, the hardware states related to application usage, or any combination thereof.

Either the server system 204 or the electronic device 202 can include an application detection module 224. The application detection module 224 is for determining a list of applications, such as an application list 226, running on or installed on the electronic device 202. The application detection module 224 can be coupled to the application model store 218 and the feature detection module 220. For each of the application model 216, the application detection module 224 can check to see if the metadata features 222 that are detected with the feature detection module 220 correspond to a positive match with the application model 216. The application list 226 can be the application list 114 of FIG. 1.

The electronic device 202 can include an active application module 228. The application detection module 224 can be coupled to the active application module 228. The active application module 228 is for detecting processes running on an electronic device, such as the electronic device 202. The active application module 228 can retrieve a set of running processes on an operating system of the electronic device 202 with a system call. The set of running processes can be sent to the application detection module 224. The application detection module 224 can analyze this list of running processes to locate and identify processes that are most likely caused by running applications known to the application detection system 200, such as from the application models store 218. The application detection module 224 can then translate the list of running processes to the application list 226.

The application detection module 224 can also include an application check module 230. The application check module 230 is for confirming that an application is installed on an electronic device, such as the electronic device 202.

The server system 204 can include a URL checker module 232. The URL checker module 232 can be coupled with the application check module 230 to test run custom URL schemes to confirm whether an application is installed.

The active application module 228 can be integrated within an operating system of the electronic device 202. When a user opens an application, the active application module 228 can immediately detect the running processes and send the set of running process names along with device information to the application detection module 224. The application check module 230 can then respond with a list of custom URL schemes based on the application list 226 generated by the application detection module 224 from the set of running processes. The list of custom URL schemes is generated and optimized for user profile targeting purposes.

The URL checker module 232 can test each of the custom URL schemes and return to the application detection module 224 the set of custom URL schemes that the electronic device 202 responds to. In one embodiment, the application list 316 can be generated based on the set of custom URL schemes that the electronic device 202 responds to. In another embodiment, the application list 316 can be confirmed or updated based on the set of custom URL scheme that the electronic device 202 responds to.

The modules described in the application detection system 200 can either run on the electronic device 202 or the server system 204. For example, the application model store 218 can be stored on the server system 204 instead of the electronic device 202, where the electronic device 202 can access each of the application models 216 individually upon request to the server system 204.

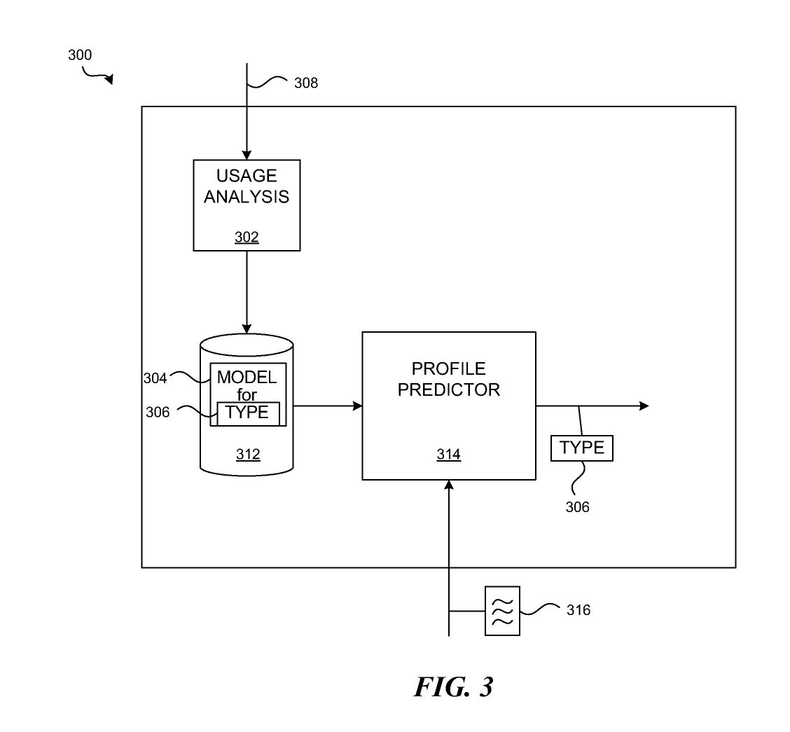

Referring now to FIG. 3, therein is shown a control flow of a consumer profiler system 300. The consumer profiler system 300 is for profiling a consumer using an electronic device. The consumer profiler system 300 can be part of the consumer target platform 100 of FIG. 1.

The consumer profiler system 300 can include one or more methods of profiling a consumer from the electronic device. The one or more methods can be implemented by components, storages, and modules described below. The modules can be implemented as hardware components, software modules, or any combination thereof. For example, the modules described can be software modules implemented as instructions on a non-transitory memory capable of being executed by a processor or a controller on a machine described in FIG. 8.

Each of the modules can operate individually and independently of other modules. Some or all of the modules can be combined as one module. A single module can also be divided into sub-modules, each performing separate method step or method steps of the single module. The modules can share access to a memory space. One module can access data accessed by or transformed by another module. The modules can be considered “coupled” to one another if they share a physical connection or a virtual connection, directly or indirectly, allowing data accessed or modified from one module to be accessed in another module.

The storages or “stores”, described below are hardware components or portions of hardware components for storing digital data. Each of the storage can be a single physical entity or distributed through multiple physical devices. Each of the storage can be on separate physical device or share the same physical device or devices. Each of the stores can allocate specific storage spaces for run-time applications.

The consumer profiler system 300 can include additional, fewer, or different modules for various applications. Conventional components such as network interfaces, security functions, load balancers, failover servers, management and network operations consoles, and the like are not shown so as to not obscure the details of the system.

The consumer profiler system 300 can include a usage analysis module 302. The usage analysis module 302 is for building a consumer profile model 304 for predicting a consumer profile type 306 of consumers based on a consumer application usage 308 on the electronic devices used by the consumers. The consumer profile type 306 can include attributes and interests of a consumer. For example, the consumer profile type 306 can be an age range, gender, school name, horoscope type, blood type, religion, sexual preference, hobby type, music preference, movie preference, or any combination thereof.

Other examples of the consumer profile type 306 can include demographics, interests, mobile or software application ownership, and whether a competitor's product or service is used. Interests can include books, business & finance, education, entertainment, games, health & fitness, lifestyle, fashion, shopping, music, news, photo & video, sports, travel, or any combination thereof. Specifically, the consumer profile type 306 can include whether the consumer's family has an infant, whether the consumer is interested in comic books, whether the consumer is interested in a TV show, whether the consumer is pregnant, favorite clothing brand, favorite sports team, recent travel plans, favorite restaurant, or any combination thereof.

The consumer application usage 308 is defined as data entries related to what applications are installed on or running on an electronic device. The consumer application usage 308, once determined, can be associated with an electronic device, such as the electronic devices 112 of FIG. 1 or the electronic device 202 of FIG. 2. The consumer application usage 308, once determined, can also be associated with a particular user identity account having operated on the electronic device.

For example, the usage analysis module 302 can generate the consumer profile model 304 based on iterative training, where the module can take in the consumer application usage 308 of consumers with known profile information in order to build correlation between known profile attributes with patterns of the consumer application usage 308. The consumer profile model 304 can be adjusted via a user interface of the usage analysis module 302. The model training of the consumer profile model 304 can be also be configured via the user interface.

The usage analysis module 302 can generate the consumer profile model 304 based on social data as well, such as from Facebook™, LinkedIn™, Twitter™, and Google™. The social data can include the consumer application usage 308. Social data can be accessed and stored via an Application Programming Interface (API). The usage analysis module 302 can also use meta data from the application stores of mobile operating system companies to generate the consumer profile model 304. From these different sources of data, the usage analysis module 302 can find correlation of application usage with specific profile categories. For example, from a user's Facebook™, the usage analysis module 302 can determine that a user is a female teenager who likes to watch movies. When it is determined that the user has installed a MovieWatcher application, the consumer profile model 304 for the female gender, the teenage age range, or the movie-watching interest can be updated to reflect an association with the MovieWatcher application.

The consumer profiler system 300 can include a profile models store 312. Each of the consumer profile model 304 generated can be recorded in the profile models store 312. The profile models store 312 is defined as a store for recording one or more of consumer profile models, such as the consumer profile model 304. The profile models store 312 can be a database implemented on non-transitory memory. The profile models store 312 can be updated by the usage analysis module 302 periodically or after every time the consumer profile model 304 is used.

The consumer profiler system 300 can include a profile predictor module 314. The profile predictor module 314 is for predicting one or more of the consumer profile type 306 of a consumer using an electronic device. The profile predictor module 314 can predict the consumer profile type 306 from an application list 316 of the consumer. The application list 316 is a list of applications installed on or running on the electronic device. The application list 316 can be the application list 114 of FIG. 1 or the application list 226 of FIG. 2.

The profile predictor module 314 can input the application list 316 as a parameter to the consumer profile model 304 of each of the consumer profile types 306 to determine whether the consumer for the application list 316 belong to the consumer profile type 306. For example, the profile predictor module 314 can input the application list 316 to a consumer profile model for the male gender and determine whether the consumer having the application list 316 is likely to be a male user.

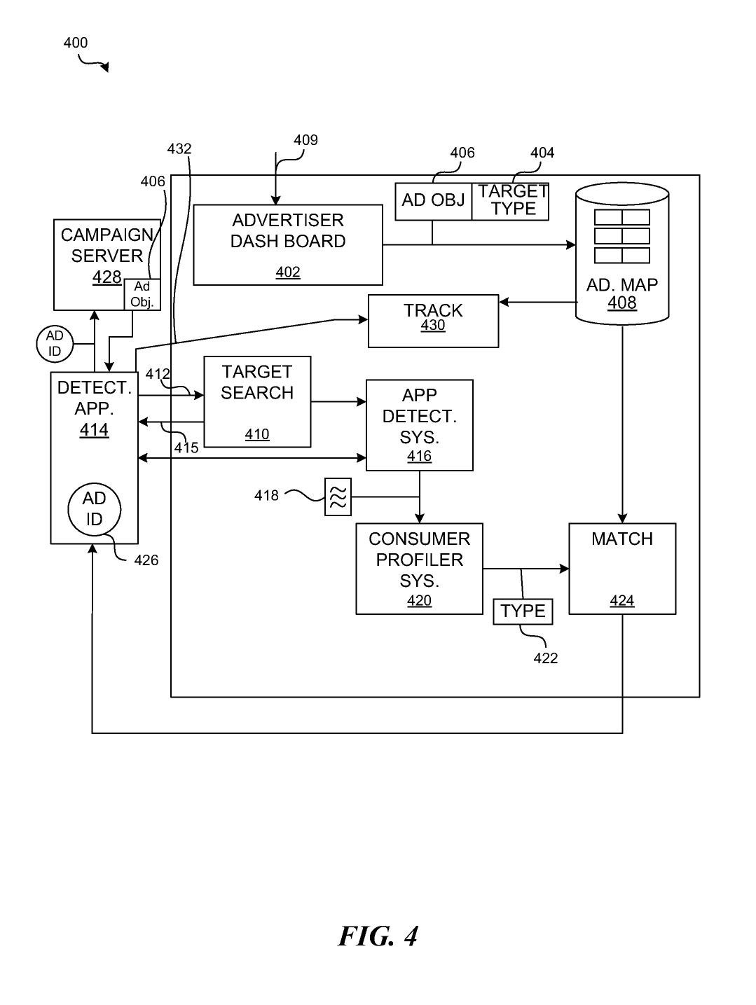

Referring now to FIG. 4, therein is shown a control flow of an advertisement targeter system 400. The advertisement targeter system 400 is for dynamically targeting consumers to present advertisements to an electronic device. In one embodiment, the advertisement targeter system 400 can dynamically target consumers in a stateless fashion without storing profiles corresponding to consumer identities or consumer device identification. The advertisement targeter system 400 can determine consumer preferences and consumer attributes in real-time.

The advertisement targeter system 400 can include one or more methods of dynamically targeting consumers. The one or more methods can be implemented by components, storages, and modules described below. The modules can be implemented as hardware components, software modules, or any combination thereof. For example, the modules described can be software modules implemented as instructions on a non-transitory memory capable of being executed by a processor or a controller on a machine described in FIG. 8.

Each of the modules can operate individually and independently of other modules. Some or all of the modules can be combined as one module. A single module can also be divided into sub-modules, each performing separate method step or method steps of the single module. The modules can share access to a memory space. One module can access data accessed by or transformed by another module. The modules can be considered “coupled” to one another if they share a physical connection or a virtual connection, directly or indirectly, allowing data accessed or modified from one module to be accessed in another module.

The storages or “stores”, described below are hardware components or portions of hardware components for storing digital data. Each of the storage can be a single physical entity or distributed through multiple physical devices. Each of the storage can be on separate physical device or share the same physical device or devices. Each of the stores can allocate specific storage spaces for run-time applications.

The advertisement targeter system 400 can include additional, fewer, or different modules for various applications. Conventional components such as network interfaces, security functions, load balancers, failover servers, management and network operations consoles, and the like are not shown so as to not obscure the details of the system. The modules described herein the advertisement targeter system 400 can either run on an electronic device, such as one of the electronic devices 112 of FIG. 1, or a server system, such as the profile server system 104 of FIG. 1.

The advertisement targeter system 400 can include an advertiser dashboard 402. The advertiser dashboard 402 is for interfacing with advertisers. For example, through the advertiser dashboard 402, an advertiser can select one or more of a target consumer type 404 for an advertisement campaign object 406. The target consumer type 404 is defined as an attribute, interest, or preference type of potential consumers that the advertiser wants to target. The advertiser dashboard 402 can provide to the advertisers a list of potential consumer types to select from based on the consumer types having a consumer profile model, such as the consumer profile model 304 of FIG. 3.

The advertisement campaign object 406 is a multimedia digital object presentable on an electronic device. For example, the advertisement campaign object 406 can be a video, an interactive application, an image, an audio clip, an animation, a text, or any combination thereof. The target consumer type 404 can be any of the examples described for the consumer profile type 306 of FIG. 3, such as demographics, interests, application preferences, or any combination thereof.

The advertiser dashboard 402 can generate an advertisement map 408 based on the target consumer type 404 and the advertisement campaign object 406 inputted by the advertisers. The advertisement map 408 is defined as a data structure that maps the advertisement campaign object 406 to one or more of the target consumer type 404.

The advertiser dashboard 402 can also register a custom URL scheme 409 associated with the advertisement campaign object 406 for a target application, wherein the custom URL scheme 409 uniquely identifies an installation of the target application. The custom URL scheme 409 can later be used to track the installation of the target application based on a consumer interaction with the advertisement campaign object 406.

The advertisement targeter system 400 can include a target search module 410. The target search module 410 is for determining which electronic devices are potential targets for presenting the advertisement campaign object 406. The target search module 410 can either receive a connection request 412 from a detection application 414 or can broadcast a report request 415 to all electronic devices having installed the detection application 414.

The detection application 414 is an application for performing detection of other applications that are running on or installed on the same device as the detection application 414. The detection application 414 can be the detection application 102 of FIG. 1 or the detection application 206 of FIG. 2.

The connection request 412 is a message from the detection application 414 to the target search module 410 when the detection application 414 comes online from an electronic device via a network channel, such as the network channel 108 of FIG. 1. The report request 415 is a message sent from the target search module 410 to the detection application 414 running on each of the electronic devices. Upon receiving the report request 415, the detection application 414 can operate an application detection system 416, such as the application detection system 200 of FIG. 2, to identify an application list 418.

The application list 418 is a list of application running or installed on the electronic device, such as the application list 114 of FIG. 1 or the application list 316 of FIG. 3. It is understood that some or all of modules of the application detection system 416 can reside on the same hardware as the advertisement targeter system 400 or on an external electronic device.

The advertisement targeter system 400 can be coupled to a consumer profiler system 420 external to the advertisement targeter system 400. Alternatively, the advertisement targeter system 400 can include the consumer profiler system 420. The consumer profiler system 420 is a system for profiling a consumer based on a list of application installed by the consumer. The consumer profiler system 420 can be the consumer profiler system 300 of FIG. 3. The consumer profiler system 420 can receive the outputs of the application detection system 416, and determine a consumer profile 422. The consumer profile 422 is defined as a set of attributes, interests, and/or preference types of the consumer having the application list 418.

The advertisement targeter system 400 can include a match module 424. The match module 424 is for matching an electronic device to specific advertisement objects based on the consumer profile 422 generated for that electronic device. The match module 424 can receive the consumer profile 422 from the consumer profiler system 420. The match module 424 can also access the advertisement map 408. For each entry of the advertisement map 408, the match module 424 can determine whether the consumer profile 422 for an electronic device matches the target consumer type 404 of the advertisement campaign object 406. The match module 424 can iterate through each of the advertisement campaign object 406. Once a match is found, the match module 424 can transmit a campaign identifier 426 of the advertisement campaign object 406 to the electronic device for presentation.

The campaign identifier 426 can be cached on the electronic device. The campaign identifier 426 can be encrypted to protect user privacy, and can only be decrypted by a key provided by the advertisement targeter system 400. The campaign identifier 426 can be sent to a campaign server 428 during an advertisement serving phase of the process. The campaign server 428 is a computer system for serving advertisement objects to electronic devices, such as the computer system 800 of FIG. 8.

The campaign server 428 can decrypt the campaign identifier 426 based on a key provided by the advertisement targeter system 400. The campaign server 428 can serve the advertisement campaign object 406, corresponding to the campaign identifier 426 received, to the electronic device for presentation.

In one embodiment, at least a set of the campaign identifier 426, that fit best according to the match module 424, is always cached on the electronic device. Because at least one instance of the campaign identifier 426 is always cached, the campaign server 428 can always serve targeted advertisement in real-time.

In one embodiment, an advertisement network or application publisher needs to integrate the advertisement targeter system 400 into either the advertiser software development kit (SDK) that is part of an application, or directly into an application. This can allow the SDK to detect installed and running applications every time the application is started, where the application has the advertisement targeter system 400 integrated.

The advertisement targeter system 400 can further include a track module 430. The track module 430 is for tracking application installations based on an advertisement campaign. The track module 430 can detect the installation of the target application based on an execution of the custom URL scheme 409. The track module 430 can then access an interaction record 432 of a user interaction with the advertisement campaign object 406 from an electronic device. The user interaction is an interaction to download or install the target application. The track module 430 can then determine a conversion confirmation based upon the interaction record 432 and the detected installation. The conversion confirmation of the installation associated the user interaction is then reported out.

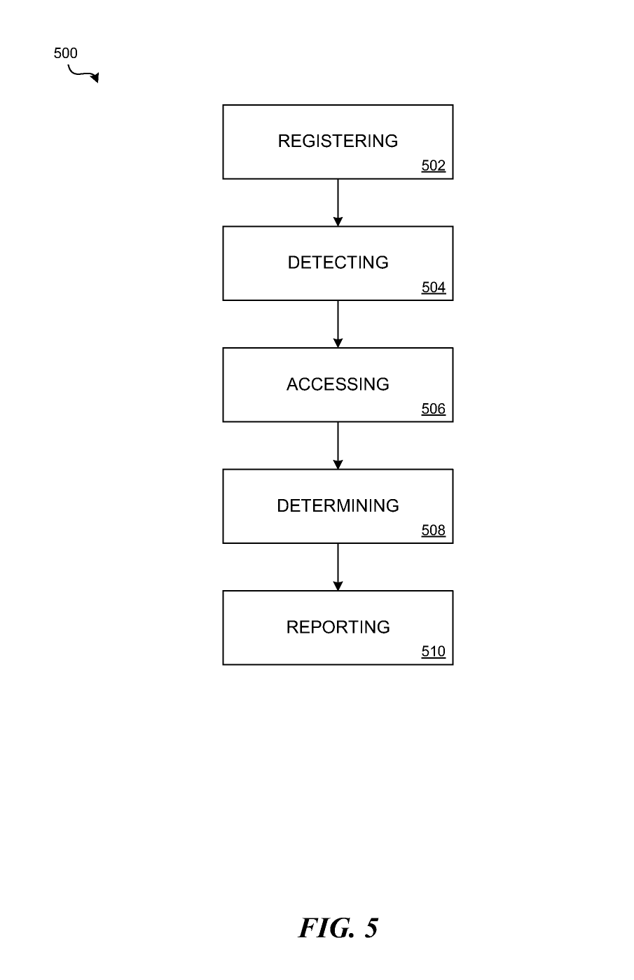

Referring now to FIG. 5, therein is shown an example of a flow chart of a method 500 of tracking application installations based on an advertisement campaign. The method 500 includes a method step 502 of registering a custom URL scheme associated with an advertisement object for a target application. The custom URL scheme can uniquely identify an installation of the target application. The method step 502 can be performed at an advertiser dashboard, such as the advertiser dashboard 402 of FIG. 4.

The method 500 includes a method step 504 of detecting the installation of the target application based on an execution of the custom URL scheme. Detecting the installation in the method step 504 can include detecting the execution of the custom URL scheme upon a first-time startup of the target application. The method step 504 can be performed by a module of an advertisement targeter system, such as the track module 430 of FIG. 4 operating on a computer server.

The method 500 also includes a method step 506 of accessing an interaction record of a user interaction with the advertisement object from an electronic device. The user interaction is for downloading the target application. In the method step 506, accessing the interaction record can include accessing a customer profile from the interaction record or accessing a unique identifier generated based on an application usage list of the electronic device.

With the interaction record, the method 500 further includes a method step 508 of determining a conversion confirmation based upon the interaction record and the detected installation. When the conversion confirmation is determined, the method 500 includes a method step 510 of reporting the conversion confirmation of the installation associated the user interaction. This includes notifying an advertisement server of a confirmed download of the target application.

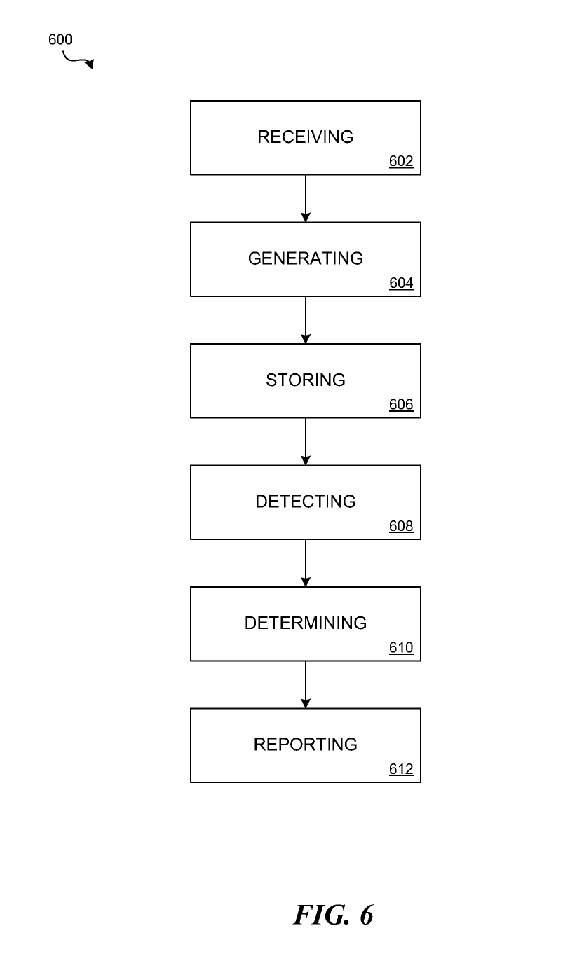

Referring now to FIG. 6, therein is shown an example of a flow chart of a method 600 of tracking an application download via an on-device application, such as the detection application 102 of FIG. 1. The method 600 includes a method step 602 of registering a custom URL scheme associated with an advertisement object. The custom URL scheme uniquely identifies an installation of a target application. The advertisement object is displayed on the electronic device when a host application is launched on the electronic device, the host application different from the target application

The method 600 also includes a method step 604 of generating a unique identifier to record a user interaction with the advertisement object on an electronic device. The user interaction is for downloading the target application. The unique identifier is for uniquely identifying an application download. The unique identifier is generated to determine whether or not the user interaction of downloading the target application was actually caused by a user clicking on the advertisement object.

For example, the unique identifier can be determined by adding a campaign identifier of the advertisement object with a time stamp. The campaign identifier is generated by an advertisement server that is accessible by a detection application on the electronic device, such as the detection application 414 of FIG. 4. The unique identifier can also be determined by adding the campaign identifier to a time stamp and a device identifier that identifies the device the advertisement object is being presented on. Other ways to generate the unique identifier can be based on a function of an application usage list of the electronic device, where the application usage list is a list of all running and/or installed applications on the electronic device. For example, generating the unique identifier can be based upon a detected list of applications or a detected list of running processes on the electronic device.

The method 600 then includes a method step 606 of storing the unique identifier. The unique identifier can be stored on a pasteboard, the pasteboard being a secure and standardized mechanism for exchange of data within or between applications on the electronic device.

Similar to the method 500 of FIG. 5, the method 600 further includes a method step 608 of detecting the installation of the target application based on an execution of the custom URL scheme. The method 600 also includes a method step 610 of determining a conversion confirmation based upon the unique identifier and the detected installation.

Because the detection application is integrated within an operating system of the electronic device, when an application launches on the electronic device for the first time, the application will immediately try to see if there is a custom URL scheme related to the advertisement campaign of the advertisement object. When there is the unique identifier available (e.g., via the pasteboard) that provides evidence that the application installation was actually caused by the user clicking on the advertisement object. These two pieces of information can then be used to determine if and when this was an actual download of the target application caused by the advertisement object. If both the unique identifier and the custom URL scheme exist, and if the application launch is within a reasonable time after the timestamp of the unique identifier, then the conversion confirmation is established.

The method 600 further includes a method step 612 of reporting the conversion confirmation of the installation associated the user interaction.

Some of the method steps described above in FIG. 5 and FIG. 6 for operation of the advertiser targeter system can be offloaded to an on-device application, such as the detection application 414 of FIG. 4. Similarly, some of the method steps described for operation of the on-device application can be offloaded to modules on a server.

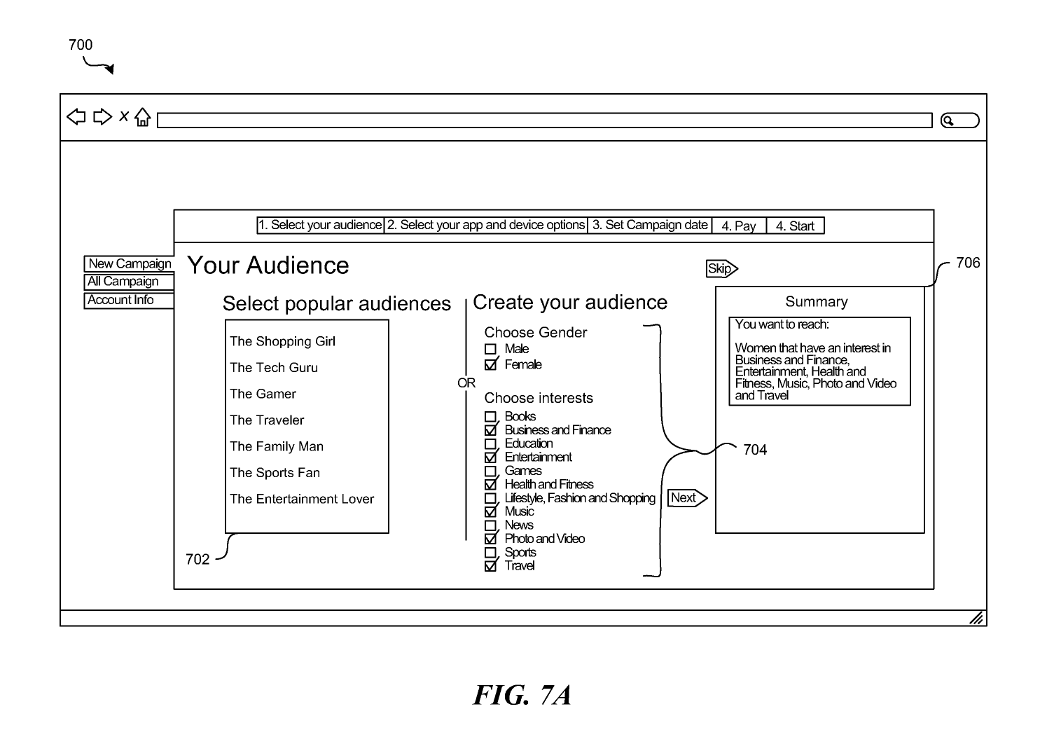

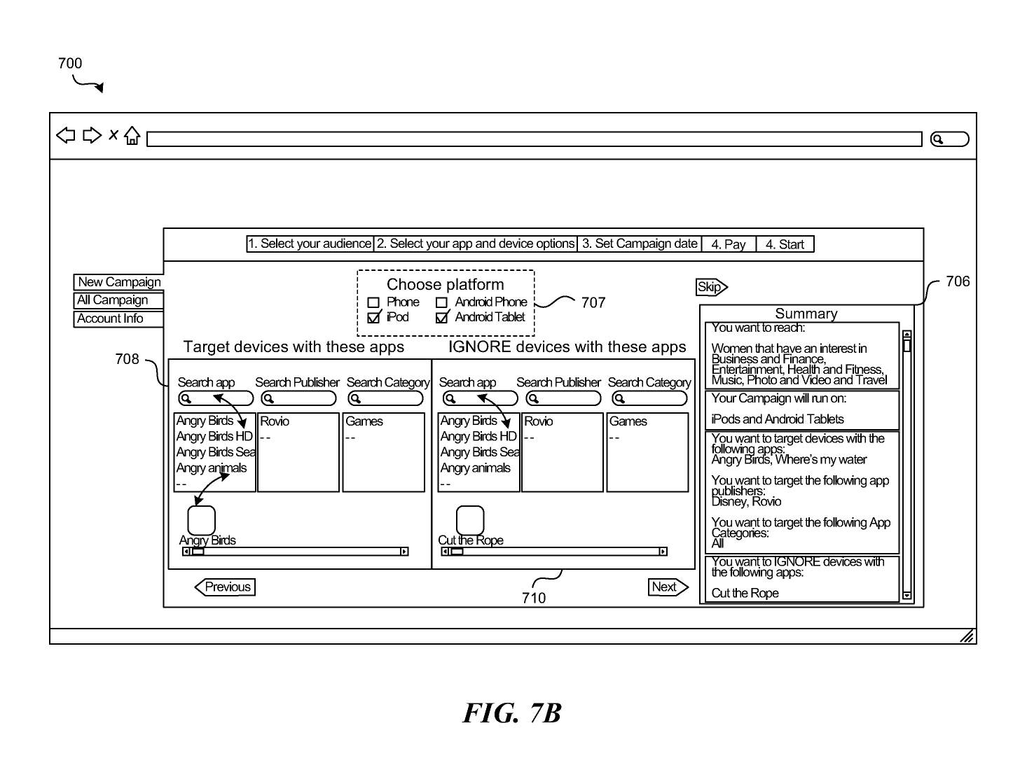

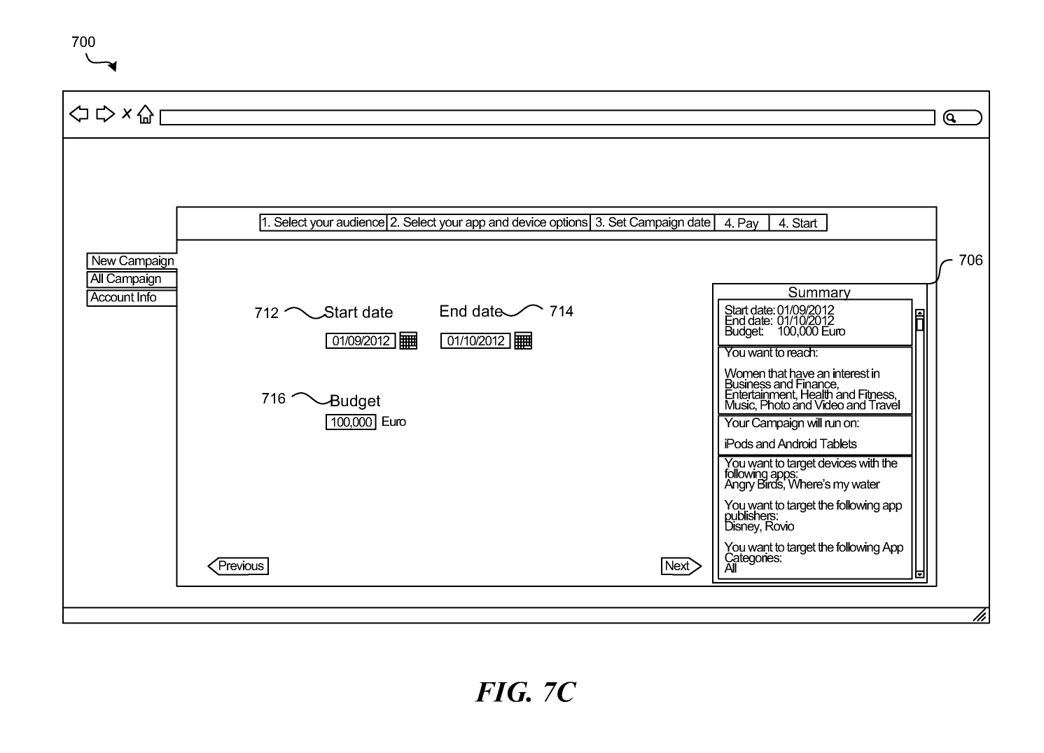

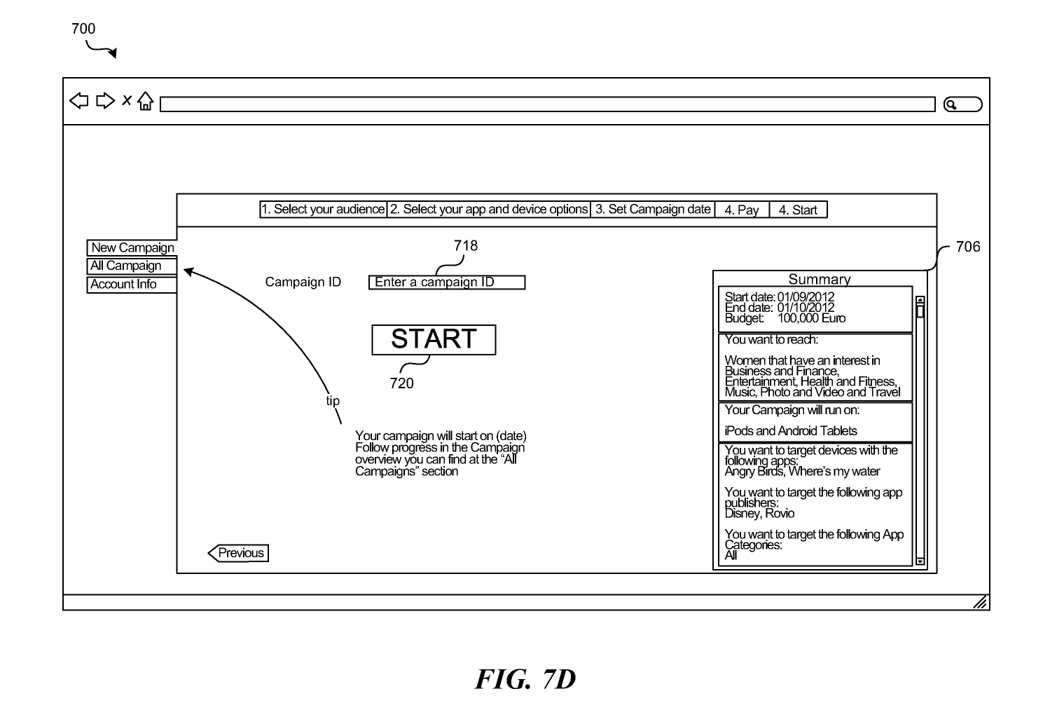

FIGS. 7A-7D illustrate examples of an advertisement dashboard 700. The advertisement dashboard 700 can be the advertisement dashboard 106 of FIG. 1.

Referring to an audience selection phase in FIG. 7A, the dashboard 700 can include a pre-defined audience type set 702. This allows an advertiser to select predefined consumer profile types. The pre-defined audience type set 702 can be based on a collection of other advertisers' selections, or can be based on a demographic analysis by grouping algorithms of consumers available to the consumer target platform 100 of FIG. 1.

For example, the pre-defined audience type set 702 can include a “shopping girl” prototype, a “tech guru” prototype, a “gamer” prototype, a “traveler” prototype, a “family man” prototype, a “sports fan” prototype, an “entertainment lover” prototype, a “bookworm” prototype, a “health and fitness” prototype, a “news reader” prototype, a “social people” prototype, a “business” prototype, a “content creator” prototype, a “fashion and lifestyle” prototype, a “shopper” prototype, or any combination thereof. One or more of the pre-defined audience type sets 702 can be selected.

The pre-defined audience type set 702 can be gender neutral. For example, the “shopping girl” prototype can include a male or female that has interests in shopping, fashion, and lifestyle. Each of the pre-defined audience type set 702 can be a persona that map onto existing targeting options, such as detailed audience types 704.

The dashboard 700 can include the detailed audience types 704. When the pre-defined audience type set 702 is selected, the detailed audience types 704 are presented on the dashboard 700. The detailed audience types can be color coded or have a consistent icon scheme throughout the dashboard 700 to serve as easy visual cues for advertisers to make their selections. The dashboard 700 can also include a target summary 706 that summarizes in plain language a description of who are the targeted audience.

Referring to an audience application and device option phase in FIG. 7B, the dashboard 700 can include targeted devices 707. The dashboard 700 can also include targeted applications 708. The targeted applications 708 are applications that should be installed on or running on the consumer's device when an advertisement object is to be presented. The targeted applications 708 can be searched via auto-text-complete. Icons of the targeted applications 708 can be displayed when the targeted applications 708 are selected. The dashboard 700 can also include application filters 710. The application filters 712 are applications that should not be on a consumer's device when an advertisement object is to be presented. Devices with these applications are ignored and avoided by the advertisement targeting system. The target summary 706 can be updated in this phase.

Referring to a campaign setting phase in FIG. 7C, the dashboard 700 can include a start date 712, an end date 714, and a budget amount 716. The target summary 706 can also be updated in this phase after the start date 712, the end date 714, and the budget amount 716 are set.

Referring to a campaign start phase in FIG. 7D, the dashboard 700 illustrates a final screen before an advertisement campaign is started. The dashboard 700 allows advertisement networks to start campaigns using the tools of the consumer target platform. The dashboard 700 can include a text box to enter a campaign identifier 718. The advertiser user can be restricted from clicking a start button 720 to start the campaign if the campaign identifier 718 cannot be matched to an advertisement campaign on an advertisement network. Again, the target summary 706 can be updated in this phase.

Referring now to FIG. 8, therein is shown a diagrammatic representation of a machine in the example form of a computer system 800 within which a set of instructions, for causing the machine to perform any one or more of the methodologies or modules discussed herein, may be executed.

In the example of FIG. 8, the computer system 800 includes a processor, memory, non-volatile memory, and an interface device. Various common components (e.g., cache memory) are omitted for illustrative simplicity. The computer system 800 is intended to illustrate a hardware device on which any of the components depicted in the example of FIGS. 1-3 (and any other components described in this specification) can be implemented. The computer system 800 can be of any applicable known or convenient type. The components of the computer system 800 can be coupled together via a bus or through some other known or convenient device.

This disclosure contemplates the computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 800 may include one or more computer systems 800; be unitary or distributed; span multiple locations; span multiple machines; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

The processor may be, for example, a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer 800. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

The bus also couples the processor to the network interface device. The interface can include one or more of a modem or network interface. It will be appreciated that a modem or network interface can be considered to be part of the computer system 800. The interface can include an analog modem, isdn modem, cable modem, token ring interface, satellite transmission interface (e.g., “direct PC”), or other interfaces for coupling a computer system to other computer systems. The interface can include one or more input and/or output devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device. For simplicity, it is assumed that controllers of any devices not depicted in the example of FIG. 8 reside in the interface.

In operation, the computer system 800 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies or modules of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting the invention to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

While processes or blocks are presented in a given order, alternative embodiments may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will begin with the words “means for”.) Accordingly, the applicants reserve the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method of tracking application installations based on an advertisement campaign comprising:
registering a custom URL scheme associated with an advertisement object for a target application, where the custom URL scheme uniquely identifies an installation of the target application;
detecting the installation of the target application based on an execution of the custom URL scheme;
accessing an interaction record of a user interaction with the advertisement object from an electronic device, the user interaction for downloading the target application;
determining a conversion confirmation based upon the interaction record and the detected installation; and
reporting the conversion confirmation of the installation associated the user interaction.

2. The method of claim 1, wherein detecting the installation includes detecting the execution of the custom URL scheme upon a first-time startup of the target application.

3. The method of claim 1, wherein accessing the interaction record includes accessing a customer profile from the interaction record.

4. The method of claim 1, wherein accessing the interaction record includes accessing a unique identifier generated based on an application usage list of the electronic device.

5. The method of claim 1, wherein reporting the conversion confirmation includes notifying an advertisement server of a confirmed download of the target application.

6. A method of tracking an application download via an on-device application comprising:
receiving a custom URL scheme associated with an advertisement object, where the custom URL scheme uniquely identifies an installation of a target application;
generating a unique identifier to record a user interaction with the advertisement object on an electronic device, the user interaction for downloading the target application;
storing the unique identifier;
detecting the installation of the target application based on an execution of the custom URL scheme;
determining a conversion confirmation based upon the unique identifier and the detected installation; and
reporting the conversion confirmation of the installation associated the user interaction.

7. The method of claim 6, wherein generating the unique identifier is based on a time stamp at a time of the user interaction.

8. The method of claim 6, wherein storing the unique identifier includes storing the unique identifier on a pasteboard, the pasteboard being a secure and standardized mechanism for exchange of data within or between applications on the electronic device.

9. The method of claim 6, further comprising displaying the advertisement object on the electronic device when a host application is launched on the electronic device, the host application different from the target application.

10. The method of claim 6, wherein the unique identifier is for uniquely identifying an application download based on a campaign identifier of the advertisement object.

11. An application install conversion tracking system comprising:
an advertiser dashboard for registering a custom URL scheme associated with an advertisement object for a target application, where the custom URL scheme uniquely identifies an installation of the target application;
detecting the installation of the target application based on an execution of the custom URL scheme;
accessing an interaction record of a user interaction with the advertisement object from an electronic device, the user interaction for downloading the target application;
determining a conversion confirmation based upon the interaction record and the detected installation; and
reporting the conversion confirmation of the installation associated the user interaction.

12. The system of claim 11, wherein the track module is for detecting the execution of the custom URL scheme upon a first-time startup of the target application.

13. The system of claim 11, wherein the track module is for accessing a customer profile from the interaction record.

14. The system of claim 11, wherein the track module is for accessing a unique identifier generated based on an application usage list of the electronic device.

15. The system of claim 11, wherein the track module is for notifying an advertisement server of a confirmed download of the target application.

16. An electronic device comprising:
a processor;
a non-transitory memory including an on-device application executable by the processor, the on-device application including executable instructions for:
receiving a custom URL scheme associated with an advertisement object, where the custom URL scheme uniquely identifies an installation of a target application;
generating a unique identifier to record a user interaction with the advertisement object on an electronic device, the user interaction for downloading the target application;
storing the unique identifier;
detecting the installation of the target application based on an execution of the custom URL scheme;
determining a conversion confirmation based upon the unique identifier and the detected installation; and
reporting the conversion confirmation of the installation associated the user interaction.

17. The electronic device of claim 16, wherein the executable instructions includes generating the unique identifier based on a time stamp at a time of the user interaction.

18. The electronic device of claim 16, wherein the executable instructions include storing the unique identifier on a pasteboard, the pasteboard being a secure and standardized mechanism for exchange of data within or between applications on the electronic device.

19. The electronic device of claim 16, wherein the executable instructions include displaying the advertisement object on the electronic device when a host application is launched on the electronic device, the host application different from the target application.

20. The electronic device of claim 16, wherein the unique identifier is for uniquely identifying an application download based on a campaign identifier of the advertisement object.
